(19) United States
(12) Patent Application Publication
(10) Pub. No.: US 2024/0152842 A1
(43) Pub. Date: May 9, 2024

(54) PREDICTIVE MODEL FOR MITIGATING COLD-START PROBLEM WITH DATA QUALITY AND QUANTITY

(71) Applicant: 6SENSE INSIGHTS, INC., San Francisco, CA (US)

(72) Inventors: Jimmy Tai, Mountain View, CA (US); Skyler Dale, Washington, DC (US); Yulia Tyutina, Minneapolis, MN (US); Swarnabha Ghosh, Pune (IN)

(21) Appl. No.: 18/384,493

(22) Filed: Oct. 27, 2023

Related U.S. Application Data
(60) Provisional application No. 63/419,856, filed on Oct. 27, 2022.

(51) Int. Cl. G06Q 10/0637

(52) U.S. Cl. CPC G06Q 10/06375

(57) ABSTRACT

When customizing a sales prediction model for a particular client, there exists a cold-start problem when the client's training data is of low quality and/or quantity. Disclosed embodiments solve this cold-start problem by normalizing the data based on weighted or unweighted recency and/or trend. In addition, the data from a wide range of clients may be used to train a base sales prediction model, which can then be fine-tuned using a particular client's data to produce a client-specific sales prediction model. A self-monitoring mechanism may be used to continually retrain the client-specific sales prediction model on new client data, to gradually improve upon the accuracy of the client-specific sales prediction model as more data become available.

### CROSS-REFERENCE TO RELATED APPLICATIONS

This application claims priority to U.S. Provisional Patent App. No. 63/419,856, filed on Oct. 27, 2022, which is hereby incorporated herein by reference as if set forth in full.

### BACKGROUND

### Field of the Invention

The embodiments described herein are generally directed to predictive models, and more particularly, to a sales prediction model that mitigates the cold-start problem with data quality and quantity.

### Description of the Related Art

U.S. Pat. No. 9,202,227 (“the '227 patent”), issued on Dec. 1, 2015, which is hereby incorporated herein by reference as if set forth in full, describes a sales prediction system. A sales prediction system may collect data, related to the online and offline activities of visitors, from multiple data sources, extract information about buying intent, and apply a sale prediction model to the data to produce a sales prediction score for each visitor and/or company with which visitors are associated. In a business-to-business (B2B) context, the sales prediction score may indicate the likelihood that a company is about to purchase a particular product or type of product. A product may be any good or service offered by a client, who utilizes the sales prediction system to identify potential customers.

Traditionally, in such a sales prediction system, each sales prediction model is customized for each client, based on data provided by the client. These data may comprise information from the client's customer relationship management (CRM) system, marketing automation platform (MAP), and/or the like.

Customizing a sales prediction model for each client is costly and time-consuming. It would be beneficial if a generalized sales prediction model could be used for all clients. However, the quality and quantity of the data will vary significantly across different clients. For example, some clients (e.g., smaller businesses) will have lower quality and/or lower quantities of data than other clients (e.g., larger businesses). This inconsistency in data quality and quantity across clients is a challenge when attempting to generalize a sales prediction model for use across all clients. This is especially important when onboarding a new client, which does not have an existing sales prediction model and may not have a significant amount of data from which to build a sales prediction model. This may be referred to herein as the “cold-start” problem.

### SUMMARY

Accordingly, systems, methods, and non-transitory computer-readable media are disclosed for a sales prediction model that mitigates the cold-start problem and enhances performance by generalizing over inconsistent data qualities and quantities.

In an embodiment, a method comprises using at least one hardware processor to: receive activity data, wherein the activity data comprise a plurality of records, wherein each of the plurality of records represents an activity of one of a plurality of activity types, and wherein each of the plurality of records is associated with one of one or more accounts; and for each of the one or more accounts, for each of the plurality of activity types, calculate a normalized metric for the activity type for the account, wherein the normalized metric is based on one or both of a recency of the activities of the activity type or a trend in the activities of the activity type, apply a sales prediction model to the normalized metrics for the plurality of activity types to determine a sales prediction score for the account, wherein the sales prediction score for the account represents a probability that the account will produce a sales opportunity, and output the sales prediction score to one or more downstream functions. The sales prediction model may comprise a Bayesian-based generalized linear model.

The normalized metric may be based on the recency of the activities of the activity type in a lookback period, and the lookback period may comprise a plurality of time intervals that are numbered from most recent to least recent. Calculating the normalized metric may comprise calculating a normalization factor by subtracting a ratio, between a number of a most recent one of the plurality of time intervals in which activity of the activity type occurred to a total number of the time intervals in the lookback period, from a value of one. The normalized metric may either consist of the normalization factor, or comprise a product of the normalized metric and another parameter.

Calculating the normalized metric may comprise: classifying each time interval, which has at least one activity, in at least a most recent subset of time intervals in the lookback window as one of a plurality of quality levels, wherein each of the plurality of quality levels is associated with a respective weight; and calculating a normalization factor as a sum of a plurality of quality-level specific products, wherein each quality-level specific product is a product of the respective weight associated with a corresponding one of the plurality of quality levels and a difference between a value of one and a ratio between a number of a most recent one of the plurality of time intervals in which activity of the corresponding quality level occurred to a total number of the time intervals in the lookback period. The quality level corresponding to each activity may represent one of a persona level of a person associated with that activity or a confidence in a mapping between that activity and the account. The quality level corresponding to each activity may represent the persona level of the person associated with that activity when the person is identified in the activity data, and the confidence in the mapping between that activity and the account when the person is not identified in the activity data.

The normalized metric may be based on the trend of the activities of the activity type in a lookback period, wherein the lookback period comprises a plurality of time intervals that are numbered from most recent to least recent, wherein the lookback period is split into a most recent period comprising a first consecutive subset of the plurality of time intervals, and a less recent period comprising a second consecutive subset of the plurality of time intervals, and wherein the first subset is more recent than the second subset. The first subset may consist of all of the plurality of time intervals that are in a most recent half of the lookback period, wherein the second subset consists of all of the plurality of time intervals that are in a least recent half of the lookback period. Calculating the normalized metric may comprise calculating a normalization factor as a ratio of a first value to a second value, wherein the first value is indicative of a number of the activities of the activity type in the most recent period, and wherein the second value is indicative of a number of activities of the activity type in the less recent period. The normalized metric may either consist of the normalization factor, or comprise a product of the normalized metric and another parameter. The first value may be a number of time intervals, which include at least one activity, in the most recent period, or a total number of activities in the most recent period, wherein the second value is a number of time intervals, which include at least one activity, in the less recent period, or a total number of activities in the less recent period. Calculating the normalized metric may comprise: classifying each time interval, which has at least one activity, in the most recent period and the less recent period as one of a plurality of quality levels, wherein each of the plurality of quality levels is associated with a respective weight; and calculating a normalization factor as ratio in which a numerator of the ratio comprises a sum of the one or more respective weights associated with the one or more quality levels into which the time intervals in the most recent period have been classified, and the denominator of the ratio comprises a sum of the one or more respective weights associated with the one or more quality levels into which the time intervals in the less recent period have been classified. The quality level corresponding to each time interval may represent a persona level of a person associated with activity in that time interval when the person is identified in the activity data, and the confidence in the mapping between activity in that time interval and the account when the person is not identified in the activity data.

The method may further comprise using the at least one hardware processor to: prior to applying the sales prediction model, train the sales prediction model using a general training dataset that comprises labeled activity data for a plurality of clients, to produce a base sales prediction model; and for at least one client, fine-tune the base sales prediction model, using a client-specific training dataset that consists of labeled activity data for only the at least one client, to produce a client-specific sales prediction model, wherein the client-specific sales prediction model is used for the received activity data for that client, and over each of one or more retraining cycles, fine-tune the client-specific sales prediction model, using a client-specific retraining dataset that comprises labeled activity data that have been acquired for the at least one client since a most recent fine-tuning of the client-specific sales prediction model, to produce a new client-specific sales prediction model, and when a performance of the new client-specific sales prediction model represents an improvement over a currently operational client-specific prediction model, replace the currently operational client-specific prediction model with the new client-specific sales prediction model. One or more of the general training dataset, the client-specific training dataset, or the client-specific retraining dataset may be generated by resampling training data based on Tomek links.

The method may further comprise using the at least one hardware processor to execute at least one of the one or more downstream functions to: detect a spike in the sales prediction score output for at least one of the one or more accounts, based on the sales prediction score and one or more previously output sales prediction scores for the at least one account, wherein the spike is represented by a rate of increase in the sales prediction score, relative to the one or more previously output sales prediction scores, that is greater than a predefined threshold; and in response to detecting the spike, alerting at least one recipient about the spike.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a prediction process, using a sales prediction model in which activities are normalized based on recency and/or trend, according to an embodiment;

FIGS. 4A and 4B illustrate timelines for use in explaining normalization based on recency, according to embodiments;

FIGS. 5A and 5B illustrate timelines for use in explaining normalization based on trend, according to embodiments; and

FIG. 6 illustrates a training process for a sales prediction model, according to an embodiment.

### DETAILED DESCRIPTION

In an embodiment, systems, methods, and non-transitory computer-readable media are disclosed for a sales prediction model that mitigates the cold-start problem by generalizing over inconsistent data qualities and quantities using recency-based and/or trend-based normalization. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

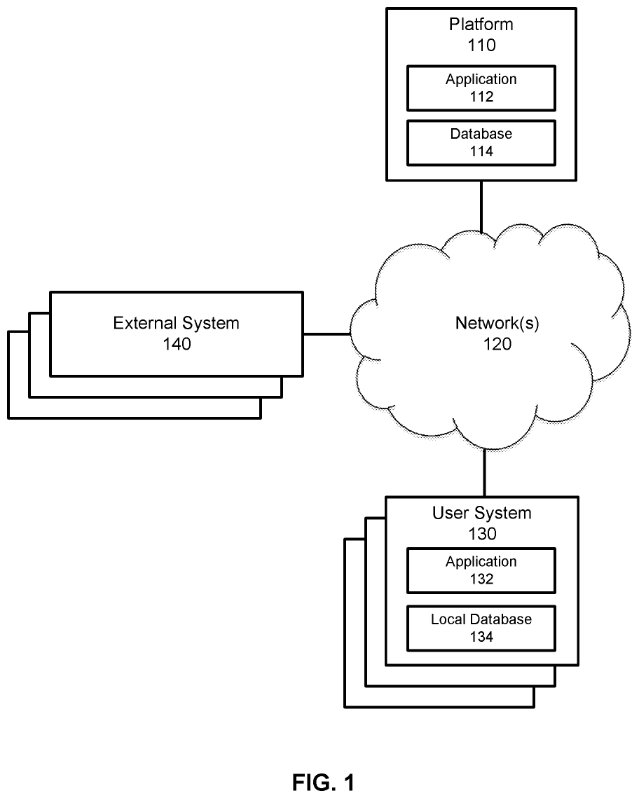

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or a database 114. In addition, platform 110 may be communicatively connected to one or more user systems 130 via one or more networks 120. Platform 110 may also be communicatively connected to one or more external systems 140 (e.g., other platforms, software applications, websites, data sources, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one database 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would typically be the personal device or professional workstation of a business development representative, administrator, or other agent of an organization engaged in sales and/or marketing of a product, such as a good or service. Each user system 130 may comprise or be communicatively connected to a client application 132 and/or a local database 134.

External system(s) 140 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that an external system 140 would typically be a data source for client data. For example, such a data source may be the CRM and/or MAP system of a client, the system of a third-party vendor (e.g., which collects and provides activity data), a website (e.g., which tracks and provides online activity data), or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database 114) that are locally and/or remotely accessible to platform 110.

Platform 110 may comprise, be communicatively coupled with, or otherwise have access to database 114. For example, platform 110 may comprise one or more database servers which manage database 114. Server application 112 executing on platform 110 and/or client application 132 executing on user system 130 may submit data (e.g., user data, form data, etc.) to be stored in database 114, and/or request access to data stored in database 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

Thus, any reference herein to a software application should be understood to refer to either a server-based application consisting of server application 112, a client-based application consisting of client application 132, or a distributed application comprising both server application 112 and client application 132. In addition, the graphical user interface, provided by such a software application, may be generated by either server application 112 or client application 132. In either case, the graphical user interface may be displayed on a display of a user system 130.

### 2. Example Processing System

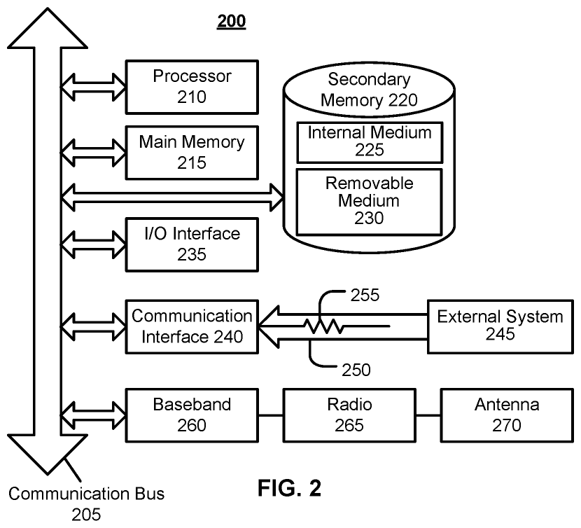

FIG. 2 is a block diagram illustrating an example wired or wireless system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smart phone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

Any of the processes described herein may be embodied in one or more software modules that are executed by processor(s) 210 of one or more processing systems 200, for example, as a service or other software application (e.g., server application 112, client application 132, and/or a distributed application comprising both server application 112 and client application 132), which may be executed wholly by processor(s) 210 of platform 110, wholly by processor(s) 210 of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component is for ease of description. Specific functions can be moved from one component to another component without departing from the disclosure.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 3. Prediction Process

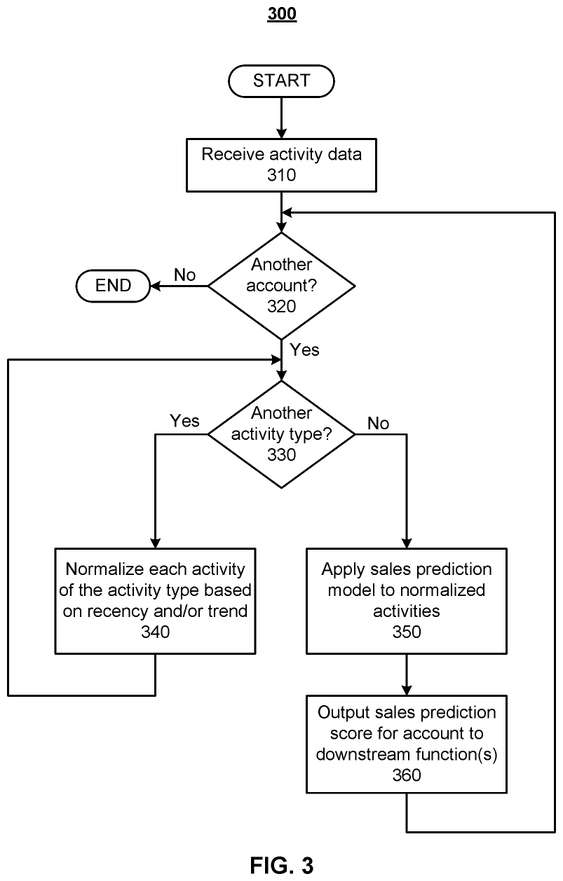

FIG. 3 illustrates a prediction process 300, using a sales prediction model in which activities are normalized based on recency and/or trend, according to an embodiment. Prediction process 300 may be implemented by server application 112. Prediction process 300 may be performed in response to a user operation, periodically (e.g., at the expiration of each of a set of successive time intervals), in response to the reception of new activity data (e.g., from external system(s) 140), and/or in response to any other triggering event. At a high level, prediction process 300 processes activity data, representing activities performed by one or more organizations (e.g., a company on the purchasing side of a B2B transaction) that are being monitored by an organization (e.g., a company on the selling side of a B2B transaction) utilizing platform 110. For clarity, the organization that is utilizing platform 110 will be referred to herein as a “client” (i.e., of platform 110), whereas any organization that is being monitored by the client via platform 110 (i.e., represented in the activity data) will be referred to herein as an “account” (e.g., of the client). An account may be any existing or potential customer of the client. Thus, the term “account” should not be understood to require that an organization actually have an account with the client.

In subprocess 310, the activity data are received. The activity data may be received from one or more external systems 140, collected by platform 110, uploaded by a user system 130, and/or obtained from any other data source. The source(s) of the activity data may include, without limitation, a website, a CRM system, a MAP system, a cookie-tracking source, third-party vendor data, and/or the like.

The activity data may comprise a plurality of records, with each of the plurality of records representing a single instance of an online or offline activity. Types of online activities include, without limitation, accessing a webpage of a web site, submitting an online form through a website, purchasing a product via an ecommerce website, reading an electronic mail (email) message, contacting a merchant or salesperson (e.g., via an online form, initiating or replying to an email message, instant-messaging chat, Short Message Service (SMS) text message, Multimedia Messaging Service (MMS) message, etc., or the like), downloading an electronic document (e.g., product brochure, white paper, etc.) from a website, and/or the like. Types of offline activities include, without limitation, attending a trade show or seminar, calling a customer-service call center, making an offline purchase, and/or the like. Each type of activity in the activity data represents a level of intent or engagement by an account.

Each of the plurality of records in the activity data may comprise an identifier of the activity type, an identifier, description, or other indication of the activity, a timestamp representing the day and time at which the activity occurred, an Internet Protocol (IP) address and/or domain representing the source of the activity, a cookie associated with the activity, and/or the like. If the specific person performing the activity is known, the record may also comprise an identifier of the person. This may occur if the activity included submitting a form with personally identifiable information (e.g., the person's name, contact information, etc.), if the activity included reading or sending a communication (e.g., email message, SMS or MMS message, etc.), if the activity was performed by a signed-in user (e.g., the person signed into a web site, such that the person can be identified from contact information associated with the user's account), and/or the like. If the specific person performing the activity is not known (e.g., an anonymous visitor to a website), the IP address, domain, and/or cookie may be mapped to a specific account. In this case, the record may also comprise an identifier of the account. An example of a method for mapping an entity, such as an IP address, domain, or cookie, to an account is described in U.S. Pat. No. 10,536,427, issued on Jan. 14, 2020, which is hereby incorporated herein by reference as if set forth in full.

In subprocess 320, process 300 iterates through each account represented in the activity data that were received in subprocess 310. For example, the activity data may be sorted primarily by account and secondarily by activity type. When another account remains to be considered from the activity data (i.e., “Yes” in subprocess 320), process 300 proceeds to subprocess 330. Otherwise, when no accounts remain to be considered from the activity data (i.e., “No” in subprocess 320), process 300 may end.

In subprocess 330, process 300 iterates through each different type of activity for the account currently under consideration. When another activity type remains to be considered for the account (i.e., “Yes” in subprocess 330), process 300 proceeds to subprocess 340. Otherwise, when no activity types remain to be considered for the account (i.e., “No” in subprocess 330), process 300 proceeds to subprocess 350.

In subprocess 340, the instances of activities, within the activity data, of the activity type currently under consideration are normalized based on one or both of recency and trend. The activity instances used to calculate the recency and/or trend may be weighted according to one or more parameters, such as the persona level(s) associated with the activities, the account-mapping confidence(s) associated with the activities, and/or the like. Embodiments of the calculations for recency and trend in subprocess 340 are discussed elsewhere herein, using specific examples. The output of each iteration of subprocess 340 may be a normalized metric representing the recency and/or trend of activities of the given activity type, within the activity data, for the given account.

In subprocess 350, the sales prediction model is applied to the normalized metrics for all of the activity types associated with the account currently under consideration. Embodiments of the sales prediction model are described in the '227 patent, as well as elsewhere herein. The output of the sales prediction model is a sales prediction score for the account currently under consideration. The sales prediction score may indicate the likelihood or probability that an account is interested in making, or about to or will make, a purchase of a product of interest in the future (e.g., a particular type of product, the product of the client, the product of a competitor of the client, etc.), the level of engagement by the account with a product or product type of interest, and/or the like. More generally, the sales prediction score may indicate the likelihood or probability that the account represents a potential sales opportunity.

In subprocess 360, the sales prediction score, output by the sales prediction model in subprocess 350, is output to one or more downstream functions. In addition, process 300 may return to subprocess 320 to determine whether or not another account remains to be considered.

The downstream function(s) may include any function that may benefit from the sales prediction score. For instance, in one example of a downstream function, the sales prediction score, output in subprocess 360 for the account currently under consideration, may be compared to one or more previously output sales prediction scores for that same account, to determine whether or not the sales prediction score has spiked (e.g., increased at a rate that is greater than a predefined threshold). When a spike in the sales prediction score of the account is detected, the downstream function may alert at least one recipient, such as a sales or marketing representative at the client, so that the representative can reach out to one or more contacts at the account, initiate targeted advertising or marketing to the account, and/or the like. Alternatively or additionally, when a spike in the sales prediction score of the account is detected, the downstream function may add contact information for the account to a marketing (e.g., telemarketing) list or the like. Alternatively or additionally, when a spike in the sales prediction score of the account is detected, the downstream function may automatically initiate advertising (e.g., an automatically generated email message or other targeted advertising) or marketing to the account.

### 4. Normalization Based on Recency

In all of the example timelines that will be discussed, time is divided into a plurality of equal time intervals. The time interval that is used is not essential to any embodiment, but for the sake of understanding, it will be assumed that the time interval is one week. It should be understood that the time interval could instead be an hour, half a day, a day, a month, or any other arbitrary and suitable period of time. In general, the time interval should reflect a suitable segmentation of the overall time span that is typical for research and purchasing decisions for the particular type of product offered by the given client.

The illustrated examples look back twelve weeks, from the current week (i.e., labeled “0”), to the immediately preceding or first past week (i.e., labeled “−1”), and so on and so forth to the eleventh past week (i.e., labeled “−11”). Each time interval in the lookback period is numbered from most recent to least recent. It should be understood that a lookback period of twelve weeks is simply one example, and that the lookback period may include any number of the time interval. For all of the examples, there is assumed to be at least one activity in the current week, the second past week (i.e., labeled “−2”), the fifth past week (i.e., labeled “−5”), the eighth past week (i.e., labeled “−8”), and the eleventh past week (i.e., labeled “−11”).

It should be understood that each timeline illustrates the instances of activities of a single activity type for a single account. In each example, the instances of activities of the given activity type for the given account are aggregated and normalized into a single normalized metric according to the relevant basis (i.e., recency or trend). Thus, through a plurality of iterations of subprocesses 330-340, normalized metrics will be produced, representing the recency or trend of each of a plurality of activity types in the activity data for the given account. The normalized metric for each activity type is used by the sales prediction model to generate a sales prediction score for the given account in subprocess 350.

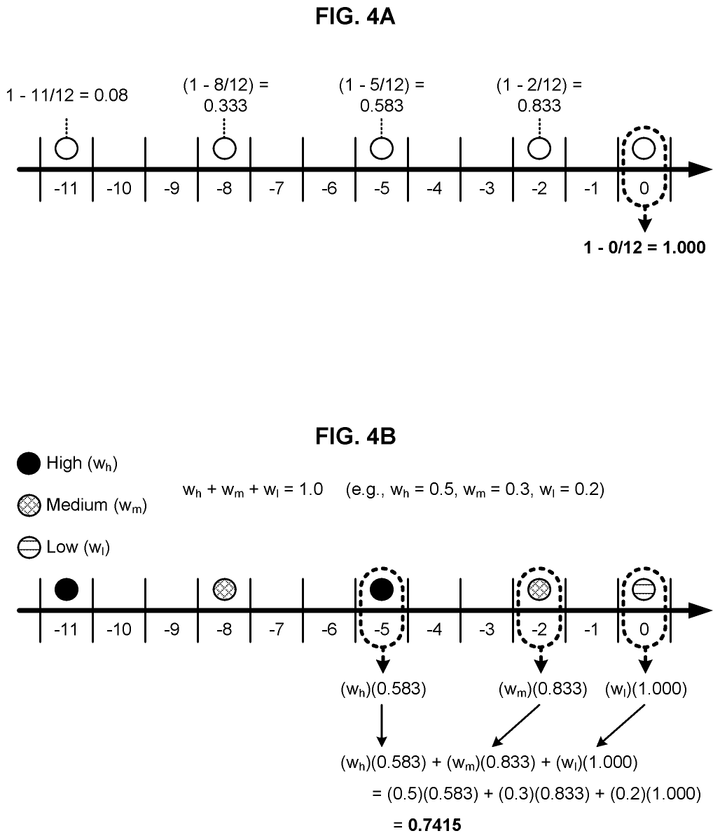

FIG. 4A illustrates a timeline for use in explaining normalization based on recency, according to an embodiment. In this embodiment, the normalization is based on the most recent week in which there is activity of the given activity type. In particular, the current week has at least one instance of the activity type. Thus, a normalization factor is calculated based on the current week. It should be understood that, in an alternative of this specific example in which there was no activity of the given activity type in the current week, the normalization factor would be calculated based on the fifth past week.

In this example, the normalization factor is calculated by subtracting the ratio, between the number of the most recent time interval in which activity of the given activity type occurred (e.g., “0” for the current week) to the total number of time intervals in the lookback period (e.g., twelve in this example), from a value of one. Thus, as the most recent time interval (e.g., week) becomes less recent (i.e., further in the past), the time-interval number will increase, which will drive the ratio higher, which will drive the normalization factor lower. In other words, the more recent the activity, the higher the normalization factor, and the less recent the activity, the lower the normalization factor. The normalization factor has a maximum of one and, in this example, the normalization factor is at the maximum, since the most recent activity occurs in the current week. If the most recent activity had instead occurred in the fifth past week, the normalization factor would be 0.583. Similarly, the normalization factor would be 0.333 if the most recent activity had instead occurred in the eighth past week, and 0.08 if the most recent activity had instead occurred in the eleventh past week.

Once determined, the normalization factor may be used in any suitable manner to produce the normalized metric for the given activity type. For example, the normalized metric may be the normalization factor itself Alternatively, the normalized metric may be the product of the normalization factor and the number of activities that occurred in the most recent week in which there was activity of the given activity type. As another alternative, the normalized metric may be the product of the normalization factor and another relevant parameter.

FIG. 4B illustrates a timeline for use in explaining normalization based on weighted recency, according to an embodiment. In this embodiment, the normalization is based on both recency of the instances of activity of the given activity type and the quality of those instances of activity. Quality may be defined by any metric, and may be classified into at least high-, medium-, and low-quality levels (e.g., by ranges of the quality metric). While only three quality levels are illustrated, it should be understood that quality may be stratified into any number of levels, including two quality levels and four or more quality levels.

Each quality level is associated with a weight. In general, the highest-quality level will be associated with the highest weight, and the lowest-quality level will be associated with the lowest weight. For example, the high-quality level is associated with a higher weight w h than the medium-quality level, and the medium-quality level is associated with a higher weight W m than the low-quality level which is associated with weight wₗ. All of the weights sum to exactly one. In other words, wₕ+wₘ+wₗ=1.0. In the illustrated example, it is assumed that (wₕ, wₘ, wₗ)=(0.5, 0.3, 0.2). However, the actual weights chosen for a particular implementation may differ, depending on the particular design goals of that implementation, the number of quality levels, and/or the like.

Each time interval in the lookback period or a most recent subset of time intervals in the lookback period may be classified into one of the plurality of quality levels. For instance, each time interval may be classified as the quality level that corresponds to the highest-quality level of activity that occurred in that time interval. As an example, if a particular time interval comprises a low-quality activity and a high-quality activity, the time interval may be classified as the high-quality level. Similarly, if a particular time interval comprises a medium-quality activity, a low-quality activity, and no high-quality activity, the time interval may be classified as the medium-quality level.

In this example, the normalization factor is calculated as the sum of quality-level specific products. Each quality-level specific product is the product of the weight for the corresponding quality level and the absolute difference between a value of one and the ratio between the number of the most recent time interval (e.g., week) in which activity of the given activity type of the corresponding quality level occurred to the total number of time intervals in the lookback period. Thus, more recent activities and higher quality activities will each drive the normalization factor higher, whereas less recent activities and lower quality activities will each drive the normalization factor lower. This forms a spectrum with very old and very low-quality activities contributing the least value to the normalization factor, very recent and very high-quality activities contributing the most value to the normalization factor, and all permutations of recency and quality level in between these two extremes.

In an embodiment, if the activity data include identifiers of the people associated with the activities, the quality is defined by the persona levels of the people associated with the instances of activity. Persona level may correspond to a job level associated with each person. In particular, people with a higher job level may correspond to higher-quality levels than people with a lower job level. As an example, the high-quality level may correspond to a c-suite executive, the medium-quality level may correspond to a manager, and the low-quality level may correspond to an unknown job level.

The job level of a person may be determined in any suitable manner. In an embodiment, the job level is determined from a job title associated with the person. Examples of how to extract information, such as job level, from a job title are described in U.S. patent application Ser. No. 18/142,730, filed on May 3, 2023, and U.S. patent application Ser. No. 18/196,130, filed on May 11, 2023, which are both hereby incorporated herein by reference as if set forth in full.

In an embodiment, the quality is defined by the confidence of the account mapping. In particular, an activity to which the account was mapped with higher confidence may correspond to higher-quality levels than an activity to which the account was mapped with lower confidence. As an example, the entity-to-account mapping described elsewhere herein may output a confidence value for each mapping of an activity to an account. The high-quality level may correspond to high confidence (e.g., confidence value is above an upper threshold), the medium-quality level may correspond to medium confidence (e.g., confidence value is below the upper threshold and above a lower threshold), and the low-quality level may correspond to low confidence (e.g., confidence value is below the lower threshold).

In an embodiment, the quality of a given record in the activity data is defined by the persona level when the record includes an identifier of a person, but is defined by the confidence of the account mapping when the record does not include an identifier of a person. In this case, the high-quality level may correspond to both a high job level (i.e., when the person is identified) and high account-mapping confidence (i.e., when the person is not identified), the medium-quality level may correspond to both a medium job level (i.e., when the person is identified) and medium account-mapping confidence (i.e., when the person is not identified), and the low-quality level may correspond to both a low (e.g., unknown) job level (i.e., when the person is identified) and low account-mapping confidence (i.e., when the person is not identified). In other words, a quality level based on job level is preferred, but a quality level based on account-mapping confidence is used when the job level is not available. Normalization based on persona level and/or account-mapping confidence can improve overall performance of the sales prediction model.

### 5. Normalization Based on Trend

For ease of understanding, the normalization based on trend will be described using the same timelines as the normalization based on recency. While the calculation of the normalization factor based on trend will differ from the calculation of the normalization factor based on recency, it should be understood that the post-calculation usage and other descriptions of the normalization factor may be the same.

In addition, normalization may be based on both recency and trend. In this case, a first normalization factor or normalized metric may be calculated based on recency, as described above, and a second normalization factor or normalized metric may be calculated based on trend, as described below. Then, the first and second normalization factor or normalized metric may be aggregated according to a suitable aggregation function. For example, the aggregation function may comprise or consist of averaging the first and second normalization factors or normalized metrics. This average may be a straight average or a weighted average. In the event of a weighted average, the first normalization factor or normalized metric, based on recency, may be weighted higher than the second normalization factor or normalized metric, based on trend. Alternatively, the first normalization factor or normalized metric may be weighted lower than the second normalization factor or normalized metric.

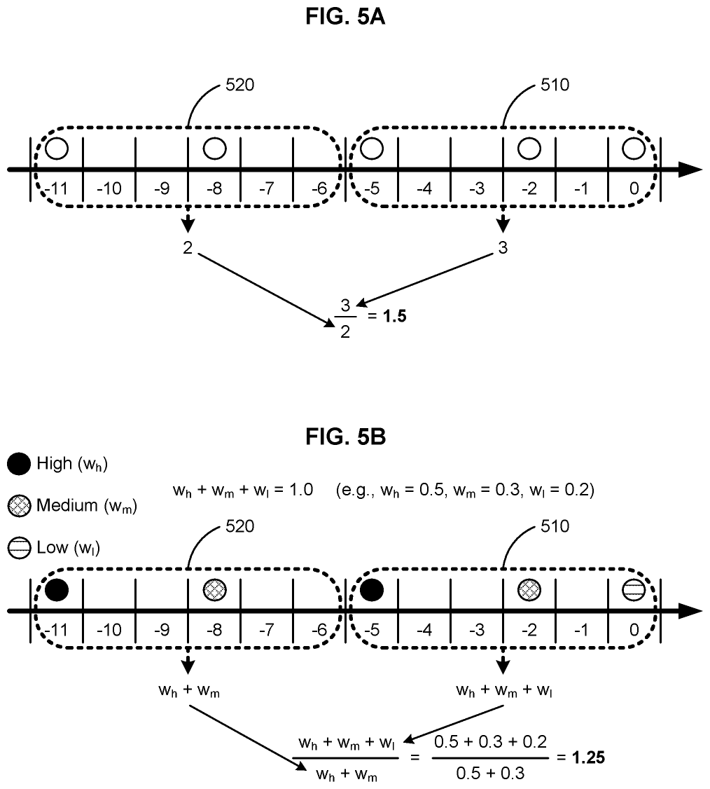

FIG. 5A illustrates a timeline for use in explaining normalization based on trend, according to an embodiment. In this embodiment, the normalization is based on a ratio of a first value (i.e., numerator), indicative of the number of activities in a most recent period 510 of the lookback window, to a second value (i.e., denominator), indicative of the number of activities in a less recent period 520 of the lookback window. In the illustrated example, the most recent period 510 of the lookback window is the most recent half of the lookback window, and the less recent period 520 of the lookback window is the least recent half of the lookback window, such that most recent period 510 and less recent period 520 are consecutive time periods within the lookback window.

In the illustrated embodiment, the normalization factor is calculated as the ratio of the number of time intervals, which include at least one activity, in most recent period 510 over the number of time intervals, which include at least one activity, in less recent period 520. Since there are three weeks with at least one activity in most recent period 510 and two weeks with at least one activity in less recent period 520, the normalization factor is calculated as 1.5. In an alternative embodiment, the normalization factor could be calculated as the ratio of the total number of activities in most recent period 510 over the total number of activities in less recent period 520.

FIG. 5B illustrates a timeline for use in explaining normalization based on weighted trend, according to an embodiment. In this embodiment, the normalization is based on both the trend in instances of activity of the given activity type and the quality of those instances of activity. Again quality may be defined by any metric, and may be classified into high-, medium-, or low-quality levels. Activities may be classified into quality levels in the same manner as described above with respect to recency, and therefore, the classification will not be redundantly described herein. For instance, as discussed above, activities may be classified into different quality levels based on persona level, account-mapping confidence, or both persona level (e.g., when the person is identified) and account-mapping confidence (e.g., when the person is not identified).

In this example, the normalization factor is calculated as the ratio between the sum of quality-specific weights for activities in most recent period 510, as the numerator, and the sum of quality-specific weights for activities in less recent period 520, as the denominator. For example, there is one high-quality activity (or time interval with at least one high-quality activity), one medium-quality activity (or time interval with at least one medium-quality activity), and one low-quality activity (or time interval with at least one low-quality activity) in most recent period 510. In addition, there is one high-quality activity (or time interval with at least one high-quality activity) and one medium-quality activity (or time interval with at least one medium-quality activity) in less recent period 520. Using the example weights, the numerator is 1.0, and the denominator is 0.8, which produces a normalization factor of 1.25.

### 6. Example Sales Prediction Model

In an embodiment, the sales prediction model comprises or consists of a Bayesian-based generalized linear model (GLM). Advantageously, such a model is interpretable and solves production overfitting challenges. For a sales prediction model in which normalization is based on both recency and trend, the Bayesian-based generalized linear model may be expressed as follows:

$$P ( Y = 1 ) = sigmoid ( {β}_{0} + {\sum }_{i = 1}^{m} {β}_{i} \cdot {F}_{R} ( {X}_{i} ) + {\sum }_{j = 1}^{m} {β}_{j} \cdot {F}_{T} ( {X}_{j} ) )$$

For a sales prediction model in which normalization is based on recency, but not trend, the Bayesian-based generalized linear model may be expressed as follows:

$$P ( Y = 1 ) = sigmoid ( {β}_{0} + {\sum }_{i = 1}^{m} {β}_{i} \cdot {F}_{R} ( {X}_{i} ) )$$

For a sales prediction model in which normalization is based on trend, but not recency, the Bayesian-based generalized linear model may be expressed as follows:

$$P ( Y = 1 ) = sigmoid ( {β}_{0} + {\sum }_{j = 1}^{m} {β}_{j} \cdot T ( {X}_{j} ) )$$

In each of the above expressions, P(Y=1) represents the probability of the given account (e.g., currently under consideration in subprocess 350) being converted to an open opportunity, sigmoid(⋅) is a sigmoid function (i.e., a mathematical function having a characteristic S-shaped or sigmoid curve), β₀ represents the intercept of the generalized linear model, Xᵢ represents activity records for a given activity type i from the activity data for the given account, Xⱼ represents activity records for a given activity type j from the activity data for the given account, F_{R}(⋅) represents the normalization function for recency (e.g., described with respect to FIGS. 4A and 4B), F_{T}(⋅) represents the normalization function for trend (e.g., described with respect to FIGS. 5A and 5B), βᵢ represents the recency-based weight for a given activity type i, and βⱼ represents the trend-based weight for a given activity type j. During training of the generalized linear model, the weights βᵢ and/or βⱼ will be adjusted to minimize the error calculated by a loss function. It should be understood that each of F_{R}(⋅) and F_{T}(⋅) accepts activity records X of a given activity type as input, and outputs a single normalized metric for the given activity type. In other words, F_{R}(⋅) and/or F_{T}(⋅) correspond to subprocess 340 of process 300.

Common challenges to building a sales prediction model for newly onboarded clients are the inconsistent quality and quantity of the clients' data. In particular, different clients have different business scales and/or resources for maintaining relevant data sources. Generally, clients with larger business scales and more resources will have higher quality and quantity of data, whereas clients with smaller business scales and fewer resources will have lower quality and quantity of data. The utilization of a Bayesian approach enables a generalized base sales prediction model to be trained from a plurality (e.g., all) of the clients' data (i.e., high quality and quantity), and, for example, stored in memory (e.g., database 114). Then, for each new client, this base sales prediction model can be retrieved and fine-tuned on the new client's data, to produce a client-specific sales prediction model. It should be understood that the sales prediction in process 300 for each client will be based on the respective client's client-specific sales prediction model, rather than the base sales prediction model.

For training the sales prediction model, a canonical loss function may be described as follows:

$$L = {\sum }_{n = 1}^{N} {( {y}^{( n )} - f ( {X}^{( n )} ) )}^{2} + λ {\sum }_{i = 1}^{k} {w}_{i}^{2}$$

wherein (y⁽ⁿ⁾−f(X⁽ⁿ⁾))² is the squared error between the ground truth y and the output of the model f(⋅) being trained given input X, and λΣᵢ₌₁^{k} wᵢ² represents the L2 loss on the weights. It should be understood that f(⋅)=P(Y=1) and βᵢ, βⱼ∈w.

With Bayes rule and Gaussian assumptions on the weights, the probability p of obtaining weights w given data D can be expressed as:

$$p ( w \vert D ) = \frac{p ( D \vert w ) p ( w )}{p ( D )} ∝ p ( D \vert w ) p ( w ) ∝ {\prod }_{n}^{N} 𝒩 ( {y}^{( n )} ; f ( {X}^{( n )} ) , {σ}_{y}^{2} ) {\prod }_{i = 1}^{K} 𝒩 ( {w}_{i} ; 0 , {σ}_{w}^{2} )$$

wherein [symbol] is the normal distribution. During training, the adjustment of the weights, based on new data, is constrained by these functions. Conceptually, the probability of obtaining a new weight is defined by the normal distribution around the cold-start weights. Taking the negative log for local minima:

$$- log [ p ( w \vert D ) ] = - {\sum }_{n - 1}^{N} log [ 𝒩 ( {y}^{( n )} ; f ( {x}^{( n )} ) , {σ}_{y}^{2} ) ] - {\sum }_{i = 1}^{K} log [ 𝒩 ( {w}_{i} ; 0 , {σ}_{w}^{2} ) ] + const . = \frac{1}{2 {σ}_{y}^{2}} {\sum }_{n - 1}^{N} {( {y}^{( n )} - f ( {X}^{( n )} ) )}^{2} - \frac{1}{2 {σ}_{w}^{2}} {\sum }_{i = 1}^{K} {w}_{i}^{2} + const .$$

This demonstrates that the negative log probability of the posterior distribution w is equivalent to the L2 regularization loss function. Optimizing the weights of the Bayesian-based generalized linear model to minimize the squared error loss function with L2 regularization is equivalent to finding the weights that are most likely under a posterior distribution, evaluated using the Bayes rule, with a zero-mean independent Gaussian weights prior. A similar idea also applies to L1 regularization with Laplace priors, or using half Cauchy priors for purposes of shrinkage without creating bias by the thin tails in the Gaussian or Laplace distribution. Any of these priors may be used to reduce the overfitting issue.

### 7. Example Self-Monitoring Mechanism

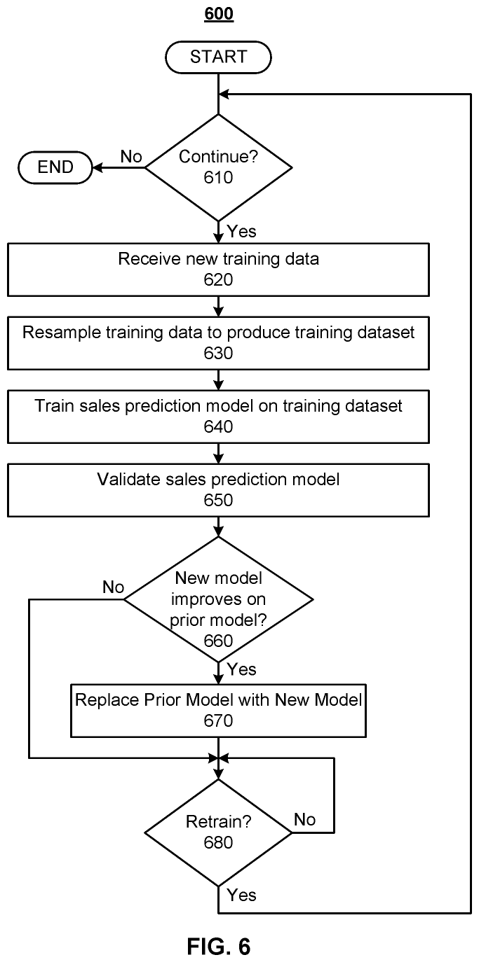

FIG. 6 illustrates a training process 600 for a sales prediction model, according to an embodiment. Training process 600 may be implemented by server application 112. At a high level, training process 600 implements a self-monitoring mechanism to continually retrain the sales prediction model, which is used in subprocess 350 of process 300 to output the sales prediction score for an account.

In subprocess 610, it is determined whether or not to continue the self-monitoring. Self-monitoring may be initiated when the client is onboarded and may continue for a predefined number (e.g., one, two, three, four, etc.) of retraining cycles, until a user operation ends the self-monitoring, and/or until the occurrence of another triggering event. When determining to continue the self-monitoring (i.e., “Yes”) in subprocess 610, process 600 proceeds to subprocess 620. Otherwise, when determining not to continue the self-monitoring (i.e., “No”) in subprocess 610, process 600 may end.

In subprocess 620, new training data are received. In an iteration of subprocess 620 that represents the initial onboarding of the client, this training data may comprise all of the activity data that the client has available. In an iteration of subprocess 620 that occurs after the initial training of the sales prediction model for the client, this training data may comprise all new activity data that the client has collected since the immediately preceding training of the sales prediction model, and optionally at least a subset of prior activity data (e.g., such that the new training data overlap with the prior training data).

The training data may comprise labeled activity data. In particular, the training data may comprise a plurality of records, with each of the plurality of records comprising one or more features (e.g., represented as a feature vector) extracted from a series of one or more activities by a customer, and labeled with a target representing whether or not the series of one or more activities resulted in an open opportunity. For example, a positive sample may be a record comprising one or more features representing a series (e.g., time series) of activities by a lead that resulted in the lead initiating a purchase from the client (e.g., labeled with an indication of an opened opportunity). Conversely, a negative sample may be a record comprising one or more features representing a series (e.g., time series) of activities by a lead that failed to result in the lead initiating a purchase from the client (e.g., labeled with an indication of no opened opportunity). It should be understood that the training data will typically comprise many more negative samples than positive samples, due to the fact that conversion rates are generally low in absolute terms.

In subprocess 630, the training data is resampled to produce a training dataset with an improved ratio of positive samples to negative samples. In other words, the ratio of positive to negative samples may be increased from an actual ratio to a desired ratio. The desired ratio may be a fixed ratio that is heuristically determined. Any suitable resampling mechanism may be used to increase the ratio of positive to negative samples. For example, new positive samples may be synthesized based on actual positive samples within the training data, and added to the training dataset. Resampling to increase samples of the minority class (i.e., positive samples in this case) may reduce variance in the resulting sales prediction model.

In an embodiment, the training data may first be searched for Tomek links. A Tomek link is a pair of positive and negative samples whose distance is smaller than their closest kind. In other words, the feature vector of the positive sample in the pair is closer, according to some distance metric, to the feature vector of the negative sample in the pair than to the feature vector of any other positive sample, and the feature vector of the negative sample in the pair is closer to the feature vector of the positive sample in the pair than to the feature vector of any other negative sample. Tomek links are noise-promoting in the data distribution. Thus, for each Tomek link, the negative sample, representing the majority class, may be removed, leaving only the positive sample from the pair. This will increase the ratio of positive samples to negative samples in the training dataset. Alternatively, both the positive sample and the negative sample in each Tomek link may be removed, to reduce noise in the data distribution. However, this will not increase the ratio of positive samples to negative samples in the training dataset.

In subprocess 640, the sales prediction model is trained based on the training dataset output by subprocess 630. The sales prediction model may be a Bayesian-based generalized linear model that is trained as described above. In general, records in the training dataset may be input to the sales prediction model to produce a sales prediction score, and a loss function may compare the output sales prediction score to the targets with which the records are labeled, to calculate an error. The weights of the sales prediction model are adjusted during the training to minimize the error calculated by the loss function. It should be understood that during training, the normalized metric will be calculated from the activity data in the training dataset and incorporated into the sales prediction model as described above.

In subprocess 650, the sales prediction model, trained in subprocess 640, may be validated. This validation may utilize a portion of the training dataset, resampled in subprocess 630, that is held back from the training in subprocess 640. Any suitable method may be used for validation in subprocess 650.

In subprocess 660, it is determined whether or not the new sales prediction model, fitted to the new training dataset by the training in subprocess 640 and validated in subprocess 650, represents an improvement in performance, according to a performance metric, over the prior and currently operational sales prediction model. The performance metric may comprise the average precision, such as the area under the curve (AUC), and/or any other suitable metric. In an initial iteration of subprocess 660 during onboarding of the client, the prior sales prediction model may simply be the generalized base sales prediction model. In each subsequent iteration of subprocess 660, the prior sales prediction model will be a pre-existing sales prediction model that was trained in a previous iteration of subprocess 640. When the new sales prediction model performs better than the prior sales prediction model (i.e., “Yes” in subprocess 660), process 600 proceeds to subprocess 670. Otherwise, when the new sales prediction model does not perform better than the prior sales prediction model (i.e., “No” in subprocess 660), process 600 skips subprocess 670, and proceeds directly to subprocess 680. This decision step ensures that the sales prediction model does not overfit on the limited data that is available for a newly onboarded client.

In subprocess 670, the new sales prediction model replaces the prior sales prediction model to be applied in subprocess 350 of process 300. For example, the prior sales prediction model may be un-deployed, and the new sales prediction model may be deployed in its place (e.g., at the same address as the prior sales prediction model). In particular, the new sales prediction model may be deployed from a training or development environment to an operating or production environment. The new sales prediction model may be deployed with an application programming interface (e.g., in a microservices architecture) that is accessible to other services on platform 110. Once deployed, the new sales prediction model will be used in iterations of subprocess 350 of process 300 for the client.

In subprocess 680, it is determined whether or not to perform another iteration in the retraining cycle of the sales prediction model. This retraining may be triggered by the expiration of a time interval (e.g., a fixed time interval, such as one week, one month, three months, six months, one year, etc.), the accumulation of a threshold amount of new activity data, a user operation, and/or any other triggering event. When it is determined to perform another iteration of training (i.e., “Yes” in subprocess 680), process 600 returns to subprocess 610. Otherwise, when it is not determined to perform another iteration of training (i.e., “No” in subprocess 680), process 600 continues to wait for the triggering event. Advantageously, this self-monitoring with automated or semi-automated retraining cycles gradually builds the accuracy of the client-specific sales prediction model over time, as the client acquires new activity data, while taking advantage of the general accuracy of the base sales prediction model when insufficient client-specific activity data are available.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive activity data, wherein the activity data comprise a plurality of records, wherein each of the plurality of records represents an activity of one of a plurality of activity types, and wherein each of the plurality of records is associated with one of one or more accounts; and
for each of the one or more accounts,
for each of the plurality of activity types, calculate a normalized metric for the activity type for the account, wherein the normalized metric is based on one or both of a recency of the activities of the activity type or a trend in the activities of the activity type,
apply a sales prediction model to the normalized metrics for the plurality of activity types to determine a sales prediction score for the account, wherein the sales prediction score for the account represents a probability that the account will produce a sales opportunity, and
output the sales prediction score to one or more downstream functions.

2. The method of claim 1, wherein the normalized metric is based on the recency of the activities of the activity type in a lookback period, and wherein the lookback period comprises a plurality of time intervals that are numbered from most recent to least recent.

3. The method of claim 2, wherein calculating the normalized metric comprises calculating a normalization factor by subtracting a ratio, between a number of a most recent one of the plurality of time intervals in which activity of the activity type occurred to a total number of the time intervals in the lookback period, from a value of one.

4. The method of claim 3, wherein the normalized metric either consists of the normalization factor, or comprises a product of the normalized metric and another parameter.

5. The method of claim 2, wherein calculating the normalized metric comprises:
classifying each time interval, which has at least one activity, in at least a most recent subset of time intervals in the lookback window as one of a plurality of quality levels, wherein each of the plurality of quality levels is associated with a respective weight; and
calculating a normalization factor as a sum of a plurality of quality-level specific products, wherein each quality-level specific product is a product of the respective weight associated with a corresponding one of the plurality of quality levels and a difference between a value of one and a ratio between a number of a most recent one of the plurality of time intervals in which activity of the corresponding quality level occurred to a total number of the time intervals in the lookback period.

6. The method of claim 5, wherein the quality level corresponding to each activity represents one of a persona level of a person associated with that activity or a confidence in a mapping between that activity and the account.

7. The method of claim 6, wherein the quality level corresponding to each activity represents the persona level of the person associated with that activity when the person is identified in the activity data, and the confidence in the mapping between that activity and the account when the person is not identified in the activity data.

8. The method of claim 1, wherein the normalized metric is based on the trend of the activities of the activity type in a lookback period, wherein the lookback period comprises a plurality of time intervals that are numbered from most recent to least recent, wherein the lookback period is split into a most recent period comprising a first consecutive subset of the plurality of time intervals, and a less recent period comprising a second consecutive subset of the plurality of time intervals, and wherein the first subset is more recent than the second subset.

9. The method of claim 8, wherein the first subset consists of all of the plurality of time intervals that are in a most recent half of the lookback period, and wherein the second subset consists of all of the plurality of time intervals that are in a least recent half of the lookback period.

10. The method of claim 8, wherein calculating the normalized metric comprises calculating a normalization factor as a ratio of a first value to a second value, wherein the first value is indicative of a number of the activities of the activity type in the most recent period, and wherein the second value is indicative of a number of activities of the activity type in the less recent period.

11. The method of claim 10, wherein the normalized metric either consists of the normalization factor, or comprises a product of the normalized metric and another parameter.

12. The method of claim 10,
wherein the first value is a number of time intervals, which include at least one activity, in the most recent period, or a total number of activities in the most recent period, and
wherein the second value is a number of time intervals, which include at least one activity, in the less recent period, or a total number of activities in the less recent period.

13. The method of claim 8, wherein calculating the normalized metric comprises:
classifying each time interval, which has at least one activity, in the most recent period and the less recent period as one of a plurality of quality levels, wherein each of the plurality of quality levels is associated with a respective weight; and
calculating a normalization factor as ratio in which a numerator of the ratio comprises a sum of the one or more respective weights associated with the one or more quality levels into which the time intervals in the most recent period have been classified, and the denominator of the ratio comprises a sum of the one or more respective weights associated with the one or more quality levels into which the time intervals in the less recent period have been classified.

14. The method of claim 13, wherein the quality level corresponding to each time interval represents a persona level of a person associated with activity in that time interval when the person is identified in the activity data, and the confidence in the mapping between activity in that time interval and the account when the person is not identified in the activity data.

15. The method of claim 1, further comprising using the at least one hardware processor to:
prior to applying the sales prediction model, train the sales prediction model using a general training dataset that comprises labeled activity data for a plurality of clients, to produce a base sales prediction model; and
for at least one client,
fine-tune the base sales prediction model, using a client-specific training dataset that consists of labeled activity data for only the at least one client, to produce a client-specific sales prediction model, wherein the client-specific sales prediction model is used for the received activity data for that client, and
over each of one or more retraining cycles,
fine-tune the client-specific sales prediction model, using a client-specific retraining dataset that comprises labeled activity data that have been acquired for the at least one client since a most recent fine-tuning of the client-specific sales prediction model, to produce a new client-specific sales prediction model, and
when a performance of the new client-specific sales prediction model represents an improvement over a currently operational client-specific prediction model, replace the currently operational client-specific prediction model with the new client-specific sales prediction model.

16. The method of claim 15, wherein one or more of the general training dataset, the client-specific training dataset, or the client-specific retraining dataset is generated by resampling training data based on Tomek links.

17. The method of claim 1, wherein the sales prediction model comprises a Bayesian-based generalized linear model.

18. The method of claim 1, further comprising using the at least one hardware processor to execute at least one of the one or more downstream functions to:
detect a spike in the sales prediction score output for at least one of the one or more accounts, based on the sales prediction score and one or more previously output sales prediction scores for the at least one account, wherein the spike is represented by a rate of increase in the sales prediction score, relative to the one or more previously output sales prediction scores, that is greater than a predefined threshold; and
in response to detecting the spike, alerting at least one recipient about the spike.

19. A system comprising:
at least one hardware processor; and
one or more software modules that are configured to, when executed by the at least one hardware processor,
receive activity data, wherein the activity data comprise a plurality of records, wherein each of the plurality of records represents an activity of one of a plurality of activity types, and wherein each of the plurality of records is associated with one of one or more accounts, and
for each of the one or more accounts,
for each of the plurality of activity types, calculate a normalized metric for the activity type for the account, wherein the normalized metric is based on one or both of a recency of the activities of the activity type or a trend in the activities of the activity type,
apply a sales prediction model to the normalized metrics for the plurality of activity types to determine a sales prediction score for the account, wherein the sales prediction score for the account represents a probability that the account will produce a sales opportunity, and
output the sales prediction score to one or more downstream functions.

20. A non-transitory computer-readable medium having instructions stored therein, wherein the instructions, when executed by a processor, cause the processor to:
receive activity data, wherein the activity data comprise a plurality of records, wherein each of the plurality of records represents an activity of one of a plurality of activity types, and wherein each of the plurality of records is associated with one of one or more accounts; and
for each of the one or more accounts,
for each of the plurality of activity types, calculate a normalized metric for the activity type for the account, wherein the normalized metric is based on one or both of a recency of the activities of the activity type or a trend in the activities of the activity type,
apply a sales prediction model to the normalized metrics for the plurality of activity types to determine a sales prediction score for the account, wherein the sales prediction score for the account represents a probability that the account will produce a sales opportunity, and
output the sales prediction score to one or more downstream functions.
